(19) United States
(12) Patent Application Publication
(10) Pub. No.: US 2006/0151254 A1
(43) Pub. Date: Jul. 13, 2006

(54) Elevator brake

(76) Inventors: Jose Sevilleja-Perez, Madrid (ES); Jose Luis Horelano-Blanco, Madrid (ES); Armando Servia-Raymundo, Madrid (ES)

Correspondence Address: OTIS ELEVATOR COMPANY;INTELLECTUAL PROPERTY DEPARTMENT, 10 FARM SPRINGS, FARMINGTON, CT, 06032, US

(21) Appl. No.: 10/500,791

(22) PCT Filed: Jan. 12, 2002
(86) PCT No.: PCT/US02/00717

§ 371 Date: Jul. 6, 2004

(51) Int. Cl. B66B 5/16

(52) U.S. Cl. 187/351

(57) ABSTRACT

An elevator brake includes a rotor (40). Preferably, a front brake lining (46) is disposed on one side of the rotor and includes two concentric annular zones. Movable first and second brake plates (42,43) are each independently acuatable into engagement with a different one of the two concentric zones of the front brake lining.

### FIELD OF TIE INVENTION

This invention relates to an improved elevator brake which is operable both to hold an elevator car at a landing during normal operation and to stop the car under emergency conditions such as power failure or overspeed. More particularly, this invention relates to a disk brake assembly that independently achieves both braking operations.

### BACKGROUND OF THE INVENTION

Passenger elevators typically include an elevator car and a counterweight suspended by elevator ropes that run over a traction sheave. An electric motor drives the sheave to move the elevator ropes, thereby driving the car and counterweight up and down an elevator shaft (or hoistway) on guide rails. When the car is stopped at a desired landing, a brake holds the sheave or the motor's output shaft, thereby keeping the car in place. The brake typically is actuated by springs and is released by a solenoid. Thus, in addition to normal braking, the brake will automatically stop the car in the event of a power outage because the solenoid will lose power. However, certain elevator regulations and codes require that the emergency stopping operation be independent of the normal stopping operation. Although two separate brakes could be employed, doing so would add significant cost, complicate installation and reduce reliability.

Thus there is a need in the art for an elevator brake assembly that can accomplish both normal and emergency braking, in which the two braking operations are independent.

### SUMMARY OF THE INVENTION

The subject invention addresses the foregoing need in the art by providing an elevator brake which is operable both during normal operation and in emergencies. Certain physical components are redundant to provide emergency stopping independent of normal stopping.

According to a preferred aspect of the subject invention, an elevator brake includes a rotor. Movable first and second brake plates are each independently acuatable into engagement with a different one of two zones on one side of the rotor.

The brake can be provided with a stationary housing facing an opposite side of the rotor, wherein the rotor is urged toward the stationary housing when either of the first and second brake plates engages the rotor. A rear brake lining can be disposed on the opposite side of the rotor, wherein the rear brake lining engages the stationary housing when the rotor is urged toward the stationary housing.

The brake may further include first and second springs biasing the first and second brake plates, respectively, toward the rotor. Independently actuatable first and second electromagnets may be provided for overcoming the bias of the first and second springs, respectively, to hold the first and second brake plates away from the rotor.

The two zones may be annular and concentric. A front brake lining may be disposed on the one side of the rotor, on the concentric zones. It is preferred that the front brake lining have two portions that are not integral with one another, each being disposed on a different one of the concentric zones. Further, the first and second brake plates may have generally semi-annular braking surfaces that oppose different sectors of the one side of the rotor.

According to another aspect, the subject invention relates to an elevator brake that includes a rotor having two concentric annular zones on one side thereof. Movable first and second brake plates are each independently acuatable into engagement with a different one of the zones. First and second springs bias the first and second brake plates, respectively, toward the one side of the rotor. Independently actuatable first and second electromagnets are provided for overcoming the bias of the first and second springs, respectively, to hold the first and second brake plates away from the rotor. A stationary housing faces an opposite side of the rotor, wherein the rotor is urged into engagement with the stationary housing when either of the first and second brake plates engages one of the zones.

It is preferred that the first and second brake plates have generally semi-annular braking surfaces that oppose different sectors of the one side of the rotor. Also, two concentric annular front brake linings may be provided, each disposed on a different one of the zones.

These and other objects, features and advantages will be made apparent in the following detailed description, with reference to the following drawings, in which like reference numerals refer to like elements throughout.

### BRIEF DESCRIPTION OF THE DRAWINGS

FIG. 1 is a schematic cross-section of a brake according to an embodiment of the subject invention.

FIG. 2 is a schematic axial view of a preferred arrangement of the brake plates of the brake shown in FIG. 1.

FIG. 3 is a schematic cross-section of a brake according to another embodiment of the subject invention.

### DETAILED DESCRIPTION OF THE PREFERRED EMBODIMENTS

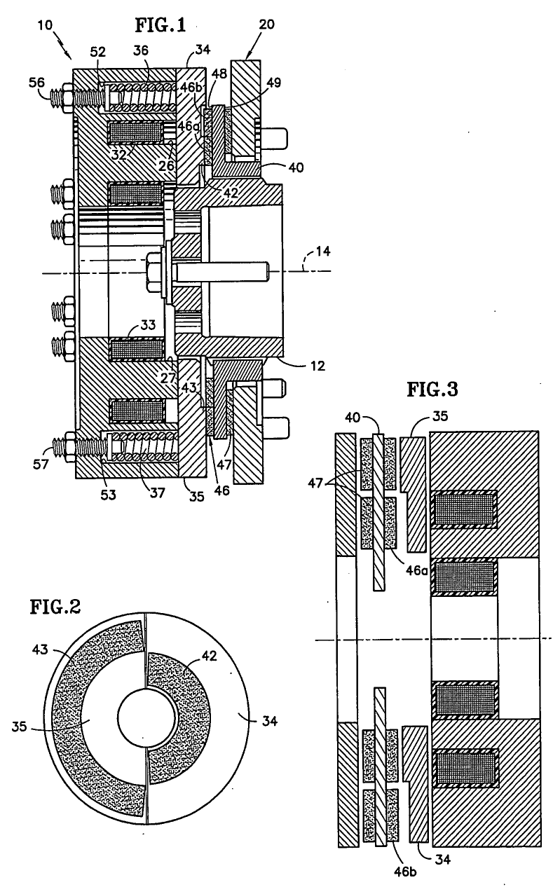

FIG. 1 shows an integrated disc brake assembly 10 according to a preferred embodiment of the subject invention. The assembly 10 comprises a housing 20, which may be secured to an outer wall of an elevator machine or gearbox housing (not shown). The assembly also includes electromagnets 32, 33, armature plates 34, 35, springs 36, 37, and a rotor 40.

The rotor 40 extends from a hub 12 that is mounted directly to a motor output shaft (not shown) of the elevator machine for rotation by the output shaft. For example, the end of the output shaft and the axis of the hub can have a bolt/socket arrangement (not shown) with complementary, axially extended, polygonal cross-sections that interlock so that the output shaft rotates the rotor 40, while the rotor 40 is permitted some small axial movement relative to the output shaft. Alternately, the hub 12 may be mounted in a similar manner to the drive sheave shaft (not shown) if the latter shaft is independent of the motor output shaft. Any other suitable mechanism for securing the hub 12 to the appropriate shaft, many of which are well known in the art (e.g., axially extended splines, etc.), may be employed.

The armature plates 34, 35 face one side 48 of the rotor 40. Preferably, the armature plates 34, 35 are semi-annular in shape, and are disposed to oppose different angular sectors of the rotor 40 (as shown schematically in FIG. 2). The springs 36, of which there are preferably at least three disposed in spring bores 52 in the housing 20, bias the armature plate 34 toward the rotor 40 in a well known manner. Likewise, preferably at least three of the springs 37 are disposed in spring bores 53 in the housing 20 and bias the armature plate 35 toward the rotor 40. The electromagnets 32, 33, which are disposed in grooves 26, 27 in the housing 20, oppose the armature plates 34, 35, respectively. The electromagnets 32, 33, when actuated, attract the armature plates 34, 35, respectively, against the bias of the springs 36, 37.

The brake plates 42, 43 oppose one face 48 of the rotor 40. In the preferred embodiment, the brake plates 42, 43 are integral with the armature plates 34, 35, respectively. Alternately, separate brake plates may be interposed between the rotor 40 and the armature plates 34, 35. The brake plates 42, 43 are semi-annular in shape, and are disposed to oppose different angular sectors of the rotor 40 and at different radial distances from the axis of rotation 14 of the rotor 40 (as shown schematically in FIG. 2). Thus, the brake plates 42, 43 each oppose approximately half of a different one of a pair concentric annular regions of the rotor 40. The rotor 40 carries annular brake linings 46, 47, which are disposed on opposite faces of the rotor 40 toward its outer end. The brake lining 46 on the one face 48 of the rotor 40 comprises concentric annular zones 46a, 46b that are opposed by the brake plates 42, 43, respectively. Although the zones 46a, 46b may be integral parts of a single lining, it is preferred that the zones 46a, 46b comprise separate linings, thus reducing the impact that wear or damage to one zone has on the fitness of the other. The brake lining 47 on the opposite face 49 of the rotor 40 may also be segregated, although differential wear is not likely to be as prevalent. While it is preferred for manufacturing simplicity that the brake linings 46, 47 be disposed on the faces 48, 49 of the rotor 40, the brake linings 46, 47 may be disposed instead on the surfaces that oppose the faces 48, 49 (i.e., on the brake plates 42, 43 on the one hand, and on the housing 20 on the other). If so, then the brake plates 42, 43 could be set at equal radial distances from the axis 14 (i.e., opposing different sectors of the same annulus of the rotor 40).

A plurality of guide dowels (not shown) are dispersed circumferentially about the brake assembly 10 in a well known manner and extend from the housing 20 through the armature plates 34, 35 (and brake plates 42, 43, if separate) to guide axial movement of these components relative to the rotor 40 when the brake is set and released. It will be appreciated from the foregoing that the rotor 40 rotates with the output shaft and elevator sheave (not shown), while the armature plates 34, 35 (and brake plates 42, 43, if separate) rotationally remain relatively stationary.

Small springs (not shown) can be employed in a known manner to maintain the separation of the rotor 40 from the housing 20 when the brake 10 is disengaged. Similarly, if the brake plates 42, 43 are separate from the armature plates 34, 35, then small springs (also not shown) can be employed to maintain their separation from the rotor 40 when the armature plates 34, 35 are retracted by the electromagnets 32, 33.

During normal operation of the elevator, the electromagnets 32, 33 are energized, magnetically attracting the armature plates 34, 35 away from the rotor 40, overcoming the bias of and compressing the actuating springs 36, 37. When the brake assembly 10 is in this “release” mode, the rotor 40 is free to rotate with the output shaft uninhibited by the brake plates 42, 43.

When normal braking is required at an elevator landing, power to the electromagnet 32 is switched off, de-energizing the electromagnet 32. The actuating springs 36 will then move the armature plate 34 (and the semi-annular brake plate 42) toward the rotor 40. The force of the springs 36 clamp the rotor 40 between the brake plate 42 and the housing 20. The brake plate 42 engages zone 46a of the brake lining 46, and the housing engages the brake lining 47, halting movement of the rotor 40. Movement of the output shaft and sheave thus is impeded and the cab is held stationary in the hoistway.

When emergency braking is required due to overspeed in either direction, power to the electromagnet 33 is switched off, de-energizing the electromagnet 33. When the electromagnet 33 de-energizes, the actuating springs 37 then move the armature plate 35 (and the semi-annular brake plate 43) toward the rotor 40. The force of the springs 37 clamp the rotor 40 between the brake plate 43 and the housing 20. Brake plate 43 engages zone 46b of the brake lining 46, and the brake lining 47 engages the housing, resisting further movement of the rotor 40. Thus, movement of the output shaft and sheave is halted and the cab stops in the hoistway. At the same time, power to the machine is interrupted. (Preferably, the electromagnet 32 will also be de-energized in such a situation, and the previously described “normal” braking operation will occur simultaneously with emergency braking. Also, in the event of a power outage, both electromagnets 32, 33 will de-energize.) After the overspeed has been remedied or power has been restored, the brake assembly 10 can be released merely by restoring power to the electromagnet 33 (and electromagnet 32).

The brake assembly 10 is thus operable for normal braking as well as emergency braking of the elevator. Since the armatures 34, 35 are actuated independently to clamp separate brake plates 42, 43 against different brake lining zones 46a, 46b (preferably provided on separate, concentric linings), the emergency braking is independent of the normal braking. The independent electromagnets 32, 33 provide electrical redundancy, while the separate springs 36, 37, brake plates 42, 43 and brake lining zones 46a, 46b provide mechanical redundancy, as required by some codes.

It is not critical which of the brake plates 42, 43 and brake lining zones 46a, 46b, respectively, are used for emergency braking, and which are used for normal braking. However, it is preferred that a higher torque be available for emergency braking. Thus, for simplicity, in the preceding discussion it is assumed that the radially outermost brake plate 43 and brake lining zone 46b are used for emergency braking. (Of course, higher braking torque could be achieved with the innermost brake plate 42 and brake lining zone 46a if the spring rate of the springs 36 exceeds that of springs 35.)

There is an additional benefit of positioning the brake lining zones 46a, 46b at different radii in the brake assembly 10. As noted above, if the spring rates of the springs 36, 37 are the same, the braking torque achieved by urging the outermost brake plate 43 against the outermost brake lining 46b will exceed the braking torque achieved with the innermost brake plate 42 and lining 46a. Thus, if the diameters of the linings and plates are selected properly, then a desired differential braking force can be achieved even if all the springs 36, 37 are adjusted the same. Thus, adjustment pins 56, 57 could be adjusted by means of a common mechanism or mounted to a single adjustment plate (not shown). Alternately, if equal braking forces are desired, the brake plates 42, 43 can cover different length arcs of their respective annuli, or cover annuli of different radial width, in order to provide different braking surface area to compensate for differences in torque.

The inventive assembly has many other advantages over utilizing two full brake assemblies to achieve the desired redundancy. For example, the reduction in parts would reduce cost, reduce installation and maintenance times, and increase reliability.

Further general descriptions of the operation and structure of an elevator drive machine and disc brakes are found in U.S. Pat. Nos. 5,201,821 and 5,226,508, which are hereby incorporated herein by reference in their entirety. Although the invention has been shown and described with respect to preferred embodiments thereof, it will be appreciated that various changes, omissions, and additions may be made thereto by those skilled in the art, without departing from the scope of the invention. For example, the armatures (and brake plates) could be fully annular and concentric, although utilizing electromagnets to actuate such an arrangement would increase space requirement. Therefore, the scope is to be determined with reference to the following claims.

We claim:

1. An elevator brake, comprising:
a rotor (40);
movable first and second brake plates (42, 43), the first and second brake plates being independently acuatable into engagement with a different one of two zones (46a, 46b) on one side (48) of the rotor.

2. The brake according to claim 1, further comprising a stationary housing (20) facing an opposite side (49) of the rotor, wherein the rotor is urged toward the stationary housing when either of the first and second brake plates engages the rotor.

3. The brake according to claim 2, further comprising a rear brake lining (47) disposed on the opposite side of the rotor, wherein the rear brake lining engages the stationary housing when the rotor is urged toward the stationary housing.

4. The brake according to claim 1, further comprising:
first and second springs (36, 37) biasing the first and second brake plates, respectively, toward the rotor; and
independently actuatable first and second electromagnets (32, 33) for overcoming the bias of the first and second springs, respectively, to hold the first and second brake plates away from the rotor.

5. The brake according to claim 1, wherein the two zones of the rotor are annular and concentric.

6. The brake according to claim 5, further comprising a front brake lining (46) disposed on the one side of the rotor, the front brake lining being disposed on the two concentric annular zones.

7. The brake according to claim 6, wherein the front brake lining includes two portions that are not integral with one another, each portion being disposed on a different one of the concentric annular zones.

8. The brake according to claim 1, wherein the first and second brake plates have generally semi-annular braking surfaces that oppose different sectors of the one side of the rotor.

9. An elevator brake, comprising:
a rotor (40) having two concentric annular zones (46a, 46b) on one side (48) thereof;
movable first and second brake plates (42, 43), the first and second brake plates being independently acuatable into engagement with a different one of the annular zones of the rotor;
first and second springs (36, 37) biasing the first and second brake plates, respectively, toward the rotor;
independently actuatable first and second electromagnets (32, 33) for overcoming the bias of the first and second springs, respectively, to hold the first and second brake plates away from the rotor; and
a stationary housing (20) facing an opposite side (49) of the rotor,
wherein the rotor is urged into engagement with the stationary housing when either of the first and second brake plates engages one of the annular zones of the rotor.

10. The brake according to claim 9, wherein the first and second brake plates have generally semi-annular braking surfaces that oppose different sectors of the one side of the rotor

11. The brake according to claim 9, further comprising two concentric annular front brake linings (46), each disposed on a different one of the annular zones of the rotor.
